(19) United States
(12) Patent Application Publication
(10) Pub. No.: US 2023/0100172 A1
(43) Pub. Date: Mar. 30, 2023

(54) ITEM MATCHING AND RECOGNITION SYSTEM

(71) Applicant: Toshiba Global Commerce Solutions Holdings Corporation, Tokyo (JP)

(72) Inventors: Michelle M. CROMPTON, Raleigh, NC (US); Robert B. HUTCHISON, Raleigh, NC (US); Judith L. ATALLAH, Raleigh, NC (US); Philip S. BROWN, Cary, NC (US); David P. LAITINEN, Raleigh, NC (US)

(21) Appl. No.: 17/490,517

(22) Filed: Sep. 30, 2021

(51) Int. Cl. G06Q 20/20; G06N 20/00

(52) U.S. Cl. CPC G06Q 20/203; G06Q 20/201; G06Q 20/208; G06N 20/00

(57) ABSTRACT

Techniques for automatic recognition of items for point of sale (POS) systems are disclosed. A request to identify a first item for purchase is received. The request includes a first image captured at a POS system. The first image is analyzed using a machine learning model configured for image recognition, and in response a first product code is determined for the first item. This includes identifying the first product code as a primary product code from among a plurality of product codes, identifying a second item relating to the first item, where the second item is visually similar to the first item, and determining a second product code for the second item. The first product code, and the second product code, are transmitted to the POS system. The POS system is configured to present the first item and the second item as options for purchase using a user interface.

### BACKGROUND

Retailers often provide purchasers with the option to undertake self-checkout, as an alternative to assisted checkout (e.g., provided by an employee of the retailer). Purchasers can use POS systems to scan and tally items, and to pay the resulting bill. Some items, however, do not include a code for automatic scanning (e.g., do not include a universal product code (UPC)). For these items, purchasers typically must use the POS system to identify the item. For example, purchasers can identify the item by reviewing pictures of item options or textual labels for item options, or by entering a product code (e.g., entering an alphanumeric product code). This can be inefficient, inaccurate, and detrimental to the retailer, and can cause frustration and delay for purchasers.

### BRIEF DESCRIPTION OF THE SEVERAL VIEWS OF THE DRAWINGS

FIG. 1 illustrates an example retail environment with automatic recognition of items for self-checkout using item matching, according to one embodiment.

FIG. 2 illustrates a controller for automatic recognition of items for self-checkout using item matching, according to one embodiment.

FIG. 3 illustrates item matching for automatic recognition of items for self-checkout, according to one embodiment.

FIG. 4 is a flowchart further illustrating item matching for automatic recognition of items for self-checkout, according to one embodiment.

FIG. 5 is a flowchart illustrating selecting a primary identifier as part of item matching for automatic recognition of items for self-checkout, according to one embodiment.

FIG. 6 is a flowchart illustrating visually similar item matching for automatic recognition of items for self-checkout, according to one embodiment.

FIG. 7 is a flowchart illustrating self-checkout using item matching for automatic recognition of items, according to an embodiment.

FIG. 8 is a flowchart illustrating automatic recognition of items, according to an embodiment.

### DETAILED DESCRIPTION

As discussed above, some retail items, for example produce, do not include a UPC or another code for automatic scanning at a POS system. In prior solutions, a purchaser is typically required to manually identify the item at the POS system, for example by searching for the item using images or textual labels, or by entering an alphanumeric product code. In an embodiment, a POS system can, instead, predict an item that a purchaser is purchasing, and can prompt the purchaser to confirm the predicted item.

For example, a POS system can include one or more image capture devices (e.g., cameras) to capture one or more images of the item. The POS system can then use image recognition techniques (e.g., machine learning (ML) techniques) to predict the item depicted in the images. The POS system can then present the purchaser with the predicted item, and allow the purchaser to confirm the prediction or select a different item (e.g., if the prediction is incorrect).

In an embodiment, however, many items are associated with multiple underlying product codes in a retail system. For example, a given produce item (e.g., an apple) can be associated with many different price look-up (PLU) codes. These multiple PLU codes can reflect different sources for the item (e.g., different suppliers) that are transparent to the user. For example, a given variety of apple could be associated with multiple different PLU codes reflecting different suppliers, without the user being aware of the differences (e.g., each PLU code could reflect the same price). In an embodiment, multiple PLU codes can also reflect visually similar, but different, items. For example, a given variety of apple could be available as multiple visually similar, but different, items, including an organic version, a non-organic version, a locally farmed version, a non-locally farmed version, etc. In an embodiment these different items could have different prices, but may not be distinguishable through image recognition.

In one embodiment, a POS system can predict the item using image recognition, and can provide the purchaser with a listing of all associated PLU codes. For example, the POS system could predict that the purchaser is purchasing a specific variety of apple, based on identifying the apple as depicted in one or more images, and could present the purchaser with all associated PLU codes to select (e.g., each PLU code used internally by a retailer). But this places the burden on the purchaser to select the correct PLU code and correct version of the item. This is inefficient, burdensome for the purchaser, and raises the potential for errors by the purchaser (e.g., selecting the wrong PLU code) or malicious behavior (e.g., selecting a PLU cost associated with a lower cost item).

In an embodiment, as discussed further below, a POS system can instead group items by PLU code (e.g., based on a stock keeping number (SKU) for the item) and can select a primary PLU code for the group. The POS system can then present the primary PLU code to the purchaser as the predicted PLU code, to avoid requiring the purchaser to select among all possible PLU codes. Further, the POS system can identify potentially visually similar products (e.g., organic and non-organic versions of produce) and can present one or more PLU codes for these items as well (e.g., representative PLU codes). The purchaser can then confirm the prediction, or select a different item, and continue with their purchase.

### Advantages to Point of Sale Systems

Advantageously, one or more of these techniques can improve prediction of items for purchase at a POS system using image recognition. For example, this can improve the performance of the POS system by enabling it to detect, using an image recognition system, an item being purchased without having to rely on the purchaser to scan a UPC or manually type in a name of the item. A purchaser can be automatically presented with a primary predicted item, after the items are grouped by PLU code. Further, a purchaser can be automatically presented with similar items (e.g., visually similar products) as part of the item prediction. Because visually similar items may not be distinguishable by an image recognition system, providing visually similar items, automatically, to a customer improves the accuracy of the prediction. In addition to the advantages described above, these techniques have many additional technical advantages. For example, improving the accuracy of prediction reduces the computational burden on the system, by lessening the number of transactions required, because accurate item prediction reduces the number of searches initiated by a user. As another example, automatically presenting visually similar alternatives reduces the need for the image recognition system (e.g., an ML model) to distinguish between minor differences in items. This can allow for a less heavily trained ML Model (e.g., requiring less training data to meet a required accuracy threshold), and can require less computationally intensive training and inference.

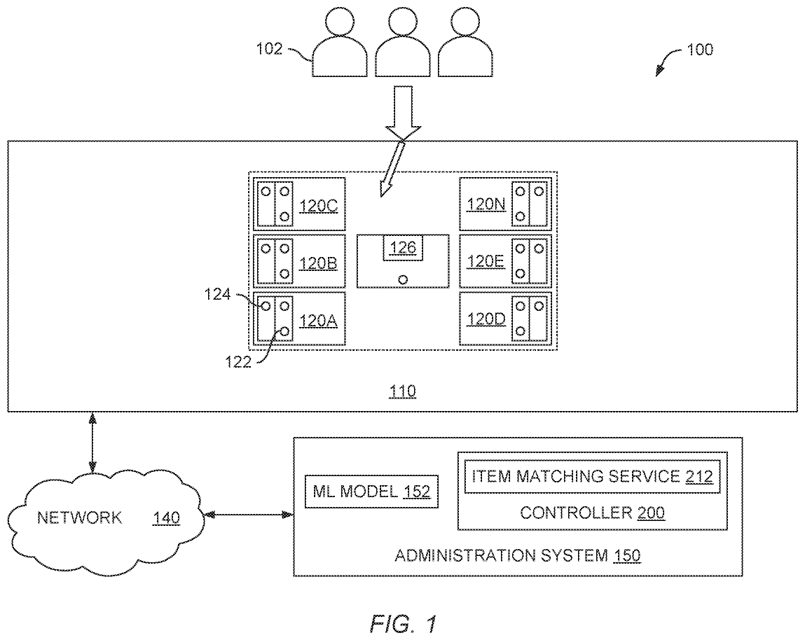

FIG. 1 illustrates an example retail environment 100 with automatic recognition of items for self-checkout using item matching, according to one embodiment. In an embodiment, the retail environment 100 relates to a retail store environment (e.g., a grocery store). This is merely one example, and the retail environment 100 can relate to any suitable environment.

One or more purchasers 102 use a checkout area 110 (e.g., to pay for purchases). In an embodiment, the checkout area 110 includes multiple POS systems 120A-N. For example, one of the purchasers 102 can use one of the POS systems 120A-N for self-checkout to purchase items. The checkout area 110 further includes an employee station 126. For example, an employee (e.g., a retail employee) can use the employee station 126 to monitor the purchasers 102 and the POS systems 120A-N. Self-checkout is merely one example, and the POS systems 120A-N can be any suitable systems. For example, the POS system 120A can be an assisted checkout system in which an employee assists a purchaser with checkout.

In an embodiment, each of the POS systems 120A-N includes components used by the purchaser for self-checkout. For example, the POS system 120A includes a UPC scanner 122 and an image capture device 124. In an embodiment, one of the purchasers 102 can use the UPC scanner 122 to identify items for checkout. For example, the purchaser 102 can use the UPC scanner 122 to scan a UPC on an item. As discussed above this is merely an example, and the UPC scanner 122 could further be used by an employee to assist with checkout.

In an embodiment, the UPC scanner 122 is a component of the POS system 120A and identifies an item for purchase based on the scanner activity. For example, the POS system 120A can communicate with an administration system 150 using a network 140. The network 140 can be any suitable communication network, including a local area network (LAN), wide area network (WAN), cellular communication network, the Internet, or any other suitable communication network. The POS system 122A can communicate with the network 140 using any suitable network connection, including a wired connection (e.g., an Ethernet connection), a WiFi connection (e.g., an 802.11 connection), or a cellular connection.

In an embodiment, the POS system 120A can communicate with the administration system 150 to identify items scanned by a purchaser 102, and to perform other functions relating to self-checkout. For example, the POS system 120A can access the administration system 150 via the network 140 to identify an item scanned using the UPC scanner 122. This is merely an example, and the administration system 150 can be fully, or partially, maintained at a local computer accessible to the POS system 120A without using a network connection (e.g., maintained on the POS system 120A itself or co-located at the same location as the POS system 120A).

Further, in an embodiment, the image capture device 124 (e.g., a camera) is also a component of the POS system 120A and can be used to identify the item that a purchaser is seeking to purchase. For example, the image capture device 124 can capture one or more images of an item a purchaser 102 is seeking to purchase. The POS system 120A can transmit the images to the administration system 150 to identify the item depicted in the images. The administration system 150 can reply to the POS system 120A with identification information for the identified item.

For example, the administration system 150 can include an ML model 152 (e.g., a supervised ML model) configured for image recognition. The ML model 152 can analyze the images and can identify the item depicted in the image. The ML model 152 can be any suitable ML model for image recognition, including a trained deep learning neural network. For example, a suitable trained convolutional neural network (CNN) can be used. This is merely one example, and any suitable ML model can be used.

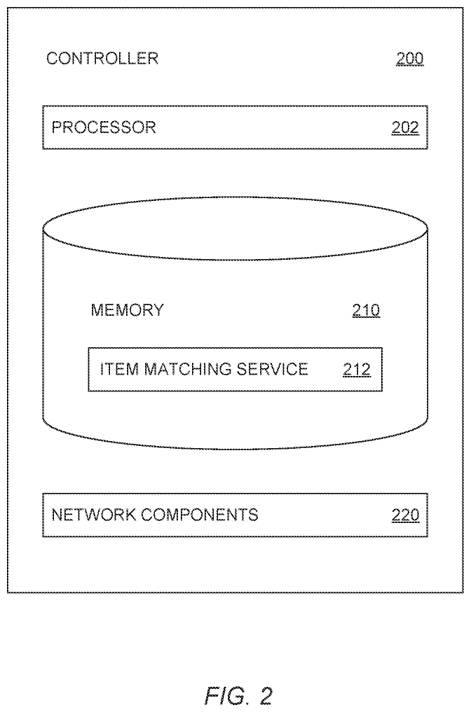

In an embodiment, the administration system 150 can determine a product code (e.g., a PLU) associated with the identified item. For example, the administration system 150 can include a controller 200 with an item matching service 212. This is discussed further below with regard to FIG. 2. In an embodiment, the item matching service 212 can identify a product code associated with the identified item (e.g., a PLU) and product codes associated with related items (e.g., visually similar items). Further, the item matching service 212 can group product codes, and identify primary product code(s) to present to a purchaser.

For example, the administration system 150 can transmit to the POS system 120A the product codes (e.g., PLUs) identifying the item and related items. The POS system 120A can use the code to lookup the items and present the items to the purchaser (e.g., displaying an image relating to the item and a textual description relating to the item). In an embodiment, information about the items presented to the purchaser (e.g., a stock image and textual description), or to an employee assisting the purchaser, is maintained at the POS system 120A. Alternatively, this information can be maintained at another suitable location. For example, the POS system 120A can communicate with any suitable storage location (e.g., a local storage location or a cloud storage location) to retrieve the information (e.g., using the identifying code for the item). Alternatively, or in addition, the administration system 150 can provide the information (e.g., the image and textual description) to the purchaser.

FIG. 2 illustrates a controller 200 for automatic recognition of items for self-checkout using item matching, according to one embodiment. The controller 200 includes a processor 202, a memory 210, and network components 220. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the controller 200 to interface with a suitable communication network (e.g., the communication network 140 illustrated in FIG. 1). For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

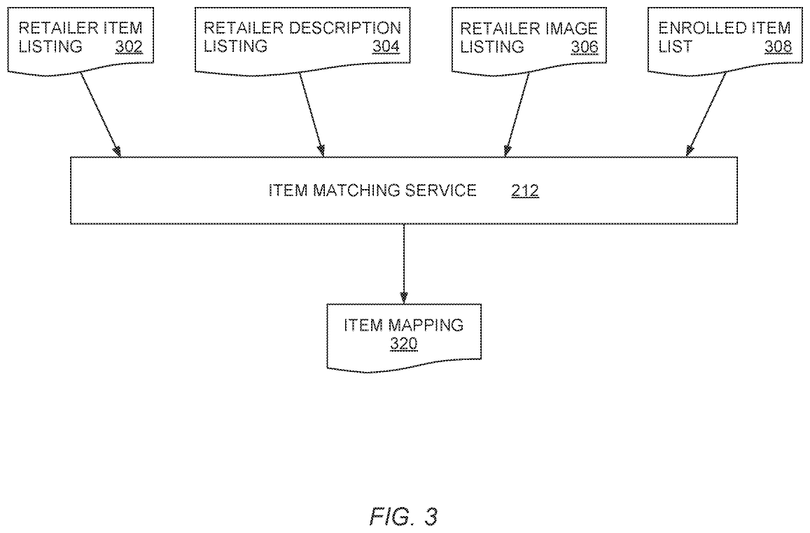

The memory 210 generally includes program code for performing various functions related to use of the controller 200. The program code is generally described as various functional “applications” or “modules” within the memory 210, although alternate implementations may have different functions and/or combinations of functions. Within the memory 210, item matching service facilitates item matching for automatic recognition of items for self-checkout. This is discussed further below with regard to FIGS. 3-6.

FIG. 3 illustrates item matching for automatic recognition of items for self-checkout, according to one embodiment. In an embodiment, an item matching service 212 (e.g., the item matching service 212 illustrated in FIGS. 1-2) matches items using data from numerous sources. For example, the item matching service 212 can receive data from three different sources associated with a retailer (e.g., a retailer offer a self-checkout service to purchasers): a retailer item listing 302, a retailer description listing 304, and a retailer image listing 306.

In an embodiment, the retailer item listing 302 includes a listing of items, including associated codes. For example, the retailer item listing 302 can include a listing of PLUs, and a SKU, associated with each item. In an embodiment, the retailer description listing 304 includes a textual description associated with items (e.g., the items included in the retailer item listing 302). For example, the retailer description listing 304 can include a name and description for each item, correlated by code (e.g., by PLU or SKU). In an embodiment, the retailer image listing 306 includes an image for display (e.g., by a POS system) associated with each item. For example, a purchaser can identify an item for purchase by selecting the item using a suitable user interface associated with the POS system (e.g., a touch sensitive interface). The POS system can display the image included in the retailer image listing 306, for each item. In an embodiment, each image in the retailer image listing 306 is correlated with the associated item using an item code (e.g., a PLU or SKU).

The item matching service 212 further receives an enrolled item list 308. In an embodiment, the enrolled item list 308 describes items that can be presented to the purchaser using an associated POS system. For example, the enrolled item list 308 can include items listed in the retailer item listing 302, or a subset of items listed in the retailer item listing 302, but can be correlated with a different code than the retailer item listing.

The item matching service 212 receives the retailer item listing 302, the retailer description listing 304, the retailer image listing 306, and the enrolled item list 308, and generates an item mapping 320. In an embodiment, the item mapping 320 includes all items (e.g., all items listed in the retailer item listing 302, the enrolled item list 308, or both). The item mapping 320 further includes an associated description (e.g., from the retailer description listing 304) and image (e.g., from the retailer image listing 306) for each item. In an embodiment, the item mapping 320 includes all codes associated with each item, including all PLUs and all SKUs.

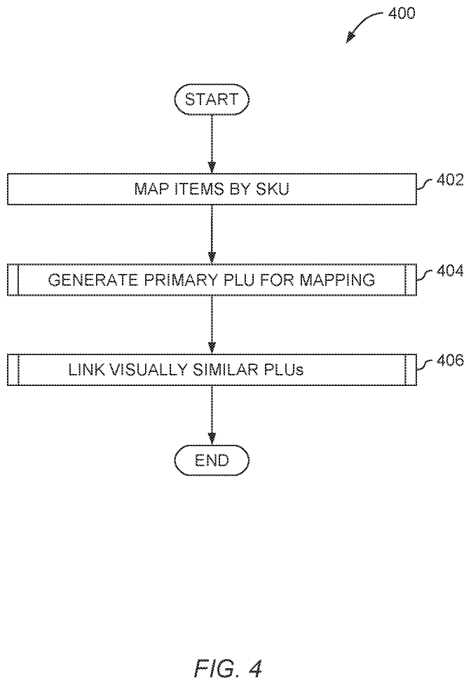

In an embodiment, the item matching service 212 uses the item mapping 320 to identify associated items and match the items together. For example, the item matching service 212 can identify items with multiple PLUs and can match the items together. Further, the item matching service 212 can identify visually similar, but not identical, items and match those items together as well. The item matching service 212 can then generate a primary PLU for each grouping of items, and the primary PLU can be used to present the item to a purchaser (e.g., a retail purchaser using a POS system) for purchaser selection. This is discussed further below with regard to FIGS. 4-6.

FIG. 4 is a flowchart 400 further illustrating item matching for automatic recognition of items for self-checkout, according to one embodiment. At block 402 an item matching service (e.g., the item matching service 212 illustrated in FIGS. 1-2) maps items by SKU. For example, the item matching service can receive an item mapping (e.g., the item mapping 320 illustrated in FIG. 3) that lists all items, with all associated codes (e.g., all associated PLUs and SKUs), descriptions, and images.

In an embodiment, the item matching service can map items so that items with matching SKUs are grouped together. For example, gala apples may be available from many different sources, and each source may be associated with a different PLU. But the SKU for gala apples can be the same, regardless of source. At block 402 the item matching service identifies all PLUs associated with the same SKU, and maps these items together by SKU.

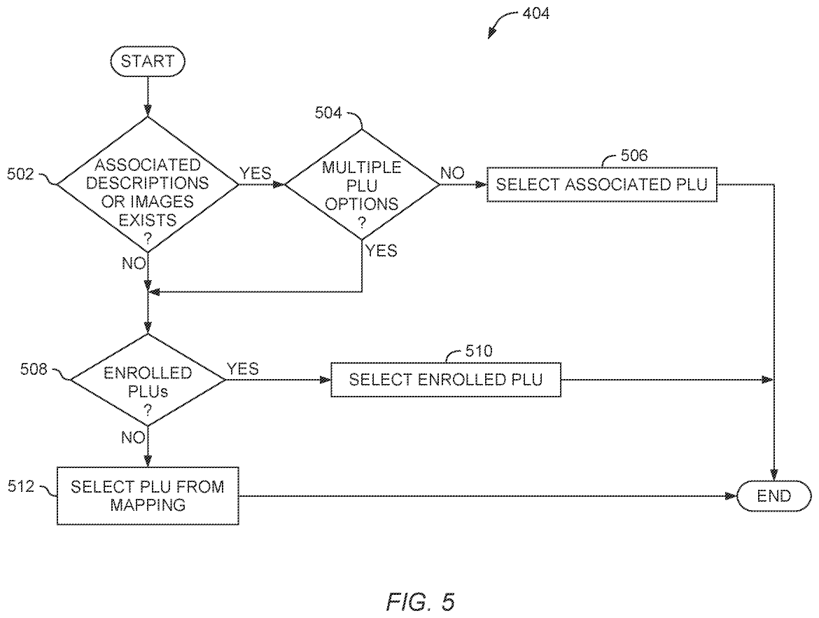

At block 404, the item matching service generates a primary PLU for the mapping. For example, as discussed above, at block 402 the item matching service maps items by SKU. In an embodiment, this results in mappings of multiple PLUs with a single SKU. The item matching service selects a primary PLU to be used for each mapping. This is discussed further below with regard to FIG. 5.

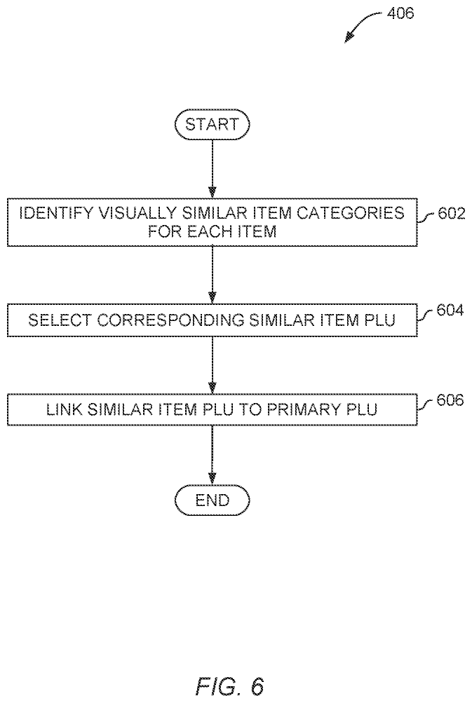

At block 406, the item matching service links visually similar PLUs. In an embodiment, as discussed above, a given item may have visually similar, but different, items available. For example, a grocery retailer may sell both organic, and non-organic, gala apples. The organic and non-organic apples are different, but are visually similar (e.g., they may appear similar in images such that they cannot be distinguished using image recognition). The item matching service links visually similar PLUs to the mapping. This is discussed further below with regard to FIG. 6.

FIG. 5 is a flowchart illustrating selecting a primary identifier as part of item matching for automatic recognition of items for self-checkout, according to one embodiment. In an embodiment, FIG. 5 corresponds with block 404 illustrated in FIG. 4. At block 502 an item matching service (e.g., the item matching service 212 illustrated in FIGS. 1-2) determines whether any associated descriptions or image already exist. For example, one or more PLUs, of the group of mapped PLUs for a given SKU, may already have associated descriptions or images for the item. If so, the flow proceeds to block 504.

At block 504, the item matching service determines whether multiple PLUs have associated descriptions or images for the item. If not (e.g., only one PLU has an associated description or image), the flow proceeds to block 506 and the item matching service selects the single PLU option. If so (e.g., multiple PLUs have an associated description or image), the item matching service must select among the multiple PLUs with associated descriptions or images for the item. In an embodiment, the item matching service proceeds to block 508 and does this by identifying whether a PLU has already been enrolled for the item, using the subset of PLUs with associated descriptions or images as the options for selection at block 508.

At block 508, the item matching service determines whether one or more PLUs have already been enrolled for the item. For example, the item may have already been enrolled with one or more PLUs. In an embodiment, at block 508 the item matching service selects among all PLUs in the group of mapped PLUs (e.g., if the flow has proceeded to block 508 from block 502). Alternatively, at block 508 the item matching service selects among the subset of PLUs with associated descriptions or images (e.g., if the flow has proceeded to block 508 from block 504).

If the item matching service identifies an enrolled PLU, the flow proceeds to block 510 and the item matching service uses the enrolled PLU. If the item matching service does not identify an enrolled PLU, the flow proceeds to block 512.

At block 512, the item matching service selects a PLU from the mapping. For example, the PLU may be a numeric value (e.g., a four digit numeric value). In this example, the item matching service can select the highest numeric value, among the PLUs associated with a given mapping, as the primary PLU. This is merely one example, and any suitable technique can be used to select the primary PLU.

FIG. 6 is a flowchart illustrating visually similar item matching for automatic recognition of items for self-checkout, according to one embodiment. In an embodiment, FIG. 6 corresponds with block 406 illustrated in FIG. 4. As discussed above, a given item may have different, but visually similar, items available. For example, a given produce item may have both organic and non-organic versions, or locally sourced and nationally sourced versions. Each of these versions may appear visually similar (e.g., may not be readily distinguishable using image recognition techniques) but may have different prices and different SKUs.

At block 602, an item matching service (e.g., the item matching service 212 illustrated in FIGS. 1-2) identifies visually similar item categories for each item. In an embodiment, visually similar items are associated with related codes. For example, visually similar items may include the same final suffix in their PLU (e.g., the same final four numerals), but different prefixes. For example, a non-organic gala apple could have a PLU 3002. An organic gala apple could add a prefix (e.g., an additional digit before 3002). The item matching service can identify different categories of visually similar items and corresponding differences in the codes (e.g., corresponding PLU prefixes).

At block 604, the item matching service selects any corresponding similar item PLUs for a given group. For example, at block 602 the item matching service could identify that a prefix “9” differentiates organic from non-organic product. For any PLU that does not begin with 9, the item matching service could search for a corresponding PLU with the same PLU suffix and the addition of a 9. For example, the item matching service could identify that a PLU 3002 does not include a prefix 9, and could search for any PLU adding the 9 (e.g., 93002). This is merely one example, and any suitable technique can be used. For example, instead of identifying visually similar item categories at block 602 (e.g., determining that organic produce adds a prefix “9”), the item matching service could search for any PLUs with the same suffix as the PLU at issue and any differing prefix (e.g., any PLU ending with 3002, regardless of prefix).

At block 606, the item matching service links similar item PLUs to the primary PLU. For example, the item matching service could identify 3002 as a primary PLU for gala apples. The item matching service could further determine that a PLU 93002 exists, and that this PLU represents visually similar organic gala apples. The item matching service can link the PLU 93002 (and its associated SKU, description, and image) with the PLU 3002.

In an embodiment, the POS system can present to the purchaser all visually similar items, together. For example, assume a POS system uses image recognition to identify that a purchaser is attempting to purchase a gala apple. The POS system can use the mapping created using the techniques of FIGS. 4-6 to present to the purchaser a single choice for non-gala apples (e.g., a primary PLU, image, and description) and a single choice for organic gala apples (e.g., the visually similar PLU linked to the primary PLU for gala apples). The purchaser can the select the appropriate item for the purchase.

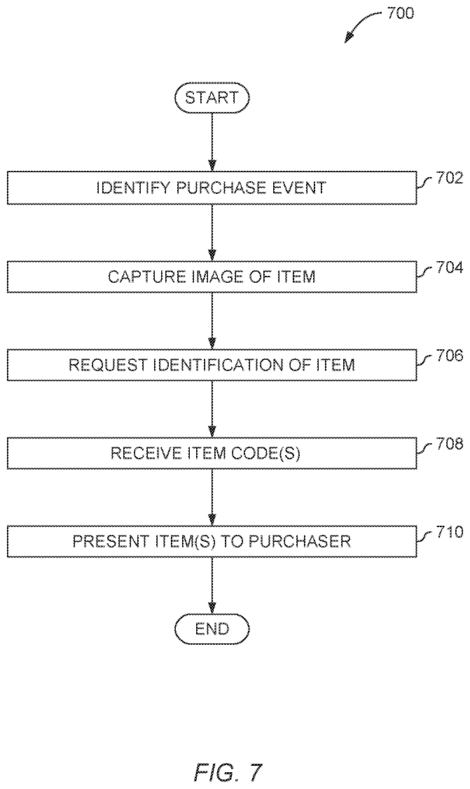

FIG. 7 is a flowchart 700 illustrating self-checkout using item matching for automatic recognition of items, according to an embodiment. At block 702 a POS system (e.g., the POS system 120A illustrated in FIG. 1) identifies a purchase event. For example, a purchaser may be attempting to purchase an item that does not include a scannable code (e.g., a UPC code). The purchase event can be triggered through interaction from the purchaser (e.g., selecting an option in a user interface), an environmental sensor (e.g., a weight or motion sensor) or in any other suitable fashion.

At block 704, the POS system captures an image of the item being purchased. For example, the POS system can include an image capture device (e.g., the image capture device 124 illustrated in FIG. 1). The image capture device can capture one or more images of the item.

At block 706, the POS system requests identification of the item. In an embodiment, the POS system can transmit the captured image(s) of the item to an item matching service (e.g., the item matching service 212 illustrated in FIGS. 1-2). For example, the POS system can transmit the image(s) to an administration system (e.g., the administration system 150 illustrated in FIG. 1) using a suitable communication network (e.g., the network 140 illustrated in FIG. 1). Alternatively, or in addition, the item matching service can reside locally at the POS system, or at a location co-located with the POS system.

As discussed above in relation to FIGS. 3-6, the item matching service can use image recognition to identify the item depicted in the captured image. Further, the item matching service can identify a primary item code (e.g., a primary PLU) associated with the item, and can identify visually similar items (e.g., organic and non-organic alternatives).

At block 708 the POS system receives the item code(s) relating to the identified item. In an embodiment, the item code(s) include both a primary code for the item (e.g., a primary PLU) and codes for any visually similar items (e.g., PLUs for organic alternatives).

At block 710, the POS system presents the items to the purchaser. For example, the POS system can use the item code(s) received at block 708 to identify enrolled items for the retailer. The POS system can present these enrolled options for a purchaser to select (e.g., using a suitable interface).

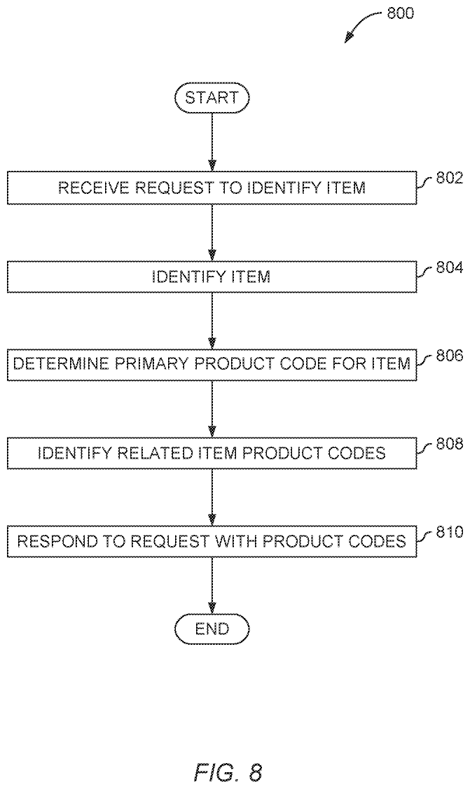

FIG. 8 is a flowchart 800 illustrating automatic recognition of items, according to an embodiment. At block 802, an item matching service (e.g., the item matching service 212 illustrated in FIGS. 1-2) receives a request to identify an item. In an embodiment, the request is transmitted by a POS system (e.g., the POS system 120A illustrated in FIG. 1) and includes one or more images captured by the POS system (e.g., using the image capture device 124).

At block 804, the item matching service identifies the item. In an embodiment, the item matching service uses image recognition to identify the item form the captured images. For example, the item matching service can use an ML model (e.g., the ML model 152 illustrated in FIG. 1) to determine an item depicted in the captured images.

At block 806, the item matching service determines a primary product code for the item. For example, the item matching service can determine a primary PLU associated with the recognized item. As discussed above in relation to FIGS. 3-6, in an embodiment an item is associated with multiple PLUs, and the item matching service can determine a primary PLU for item from these multiple PLUs.

At block 808, the item matching service identifies related item product codes. As discussed above in relation to FIG. 6, an item may have visually similar counterparts. For example, a produce item may be available in organic and non-organic versions. These items may be visually indistinguishable, but different items. As discussed above, the item matching service can identify any related item product codes (e.g., for the item identified at block 804).

At block 810, the item matching service responds to the request with the product codes. In an embodiment, the item matching service does not identify related product codes at block 808, and returns only the primary product code determined at block 806. Alternatively, the item matching service identifies one or more related product codes and returns both the primary product code and the related product codes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the administration system 150 illustrated in FIG. 1) or related data available in the cloud. For example, the administration system 150 could execute on a computing system in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

1. A method comprising:
receiving a request to identify a first item for purchase, the request comprising a first image captured at a point of sale (POS) system relating to the purchase;
analyzing the first image using a machine learning (ML) model configured for image recognition, wherein the ML model is a supervised ML model trained to recognize items for purchase in captured images using a plurality of training data, and in response determining a first product code for the first item, comprising:
identifying the first product code as a primary product code from among a plurality of product codes for the first item;
identifying a second item relating to the first item, wherein the second item is associated with a second product code that differs from the first product code and is visually similar to the first item such that the ML model is not configured to distinguish between the first item and the second item in an image depicting one of the first item or the second item, and determining the second product code for the second item; and
transmitting the first product code and the second product code to the POS system, wherein the POS system is configured to present the first item and the second item as options for purchase using a user interface.

2. The method of claim 1 wherein identifying the first product code as the primary product code from among a plurality of product codes for the first item comprises selecting the primary product code based on at least one of: (i) determining that the primary product code comprises associated description or image data, (2) determining that the primary product code is enrolled in a retailer system, or (3) determining a numeric value relating to the primary product code.

3. (canceled)

4. The method of claim 2, wherein identifying the first product code as the primary product code from among a plurality of product codes for the first item comprises selecting the primary product code based on determining that the primary product code is enrolled in a retailer system.

5. The method of claim 2, wherein identifying the first product code as the primary product code from among a plurality of product codes for the first item comprises selecting the primary product code based on determining a numeric value relating to the primary product code.

6. The method of claim 1, wherein the first item comprises a produce item and the second item comprises an organic version of the produce item.

7. The method of claim 6, wherein the determining the second product code for the second item relating to the first item comprises searching for one or more product codes relating to the first product code.

8. The method of claim 7, wherein searching for one or more product codes relating to the first product code comprises searching for one or more product codes comprising the first product code with an added prefix value.

9. The method of claim 1, wherein the ML model comprises a convolutional neural network.

10. A non-transitory computer-readable medium containing computer program code that, when executed by operation of a computer processor, performs an operation comprising:
receiving a request to identify a first item for purchase, the request comprising a first image captured at a point of sale (POS) system relating to the purchase;
analyzing the first image using a machine learning (ML) the ML model configured for image recognition, wherein the ML model is a supervised ML model trained to recognize items for purchase in captured images using a plurality of training data, and in response determining a first product code for the first item, comprising:
identifying the first product code as a primary product code from among a plurality of product codes for the first item;
identifying a second item relating to the first item, wherein the second item is associated with a second product code that differs from the first product code and is visually similar to the first item such that the ML model is not configured to distinguish between the first item and the second item in an image depicting one of the first item or the second item, and determining the second product code for the second item; and
transmitting the first product code and the second product code to the POS system, wherein the POS system is configured to present the first item and the second item as options for purchase using a user interface.

11. The non-transitory computer-readable medium of claim 10 wherein identifying the first product code as the primary product code from among a plurality of product codes for the first item comprises selecting the primary product code based on at least one of: (i) determining that the primary product code comprises associated description or image data, (2) determining that the primary product code is enrolled in a retailer system, or (3) determining a numeric value relating to the primary product code.

12. The non-transitory computer-readable medium of claim 10, wherein the first item comprises a produce item and the second item comprises an organic version of the produce item.

13. The non-transitory computer-readable medium of claim 12, wherein the determining the second product code for the second item relating to the first item comprises searching for one or more product codes relating to the first product code.

14. The non-transitory computer-readable medium of claim 13, wherein searching for one or more product codes relating to the first product code comprises searching for one or more product codes comprising the first product code with an added prefix value.

15. The non-transitory computer-readable medium of claim 10, wherein the ML model comprises a convolutional neural network.

16. A system, comprising:
a computer processor; and
a memory having instructions stored thereon which, when executed on the computer processor, performs an operation comprising:
receiving a request to identify a first item for purchase, the request comprising a first image captured at a point of sale (POS) system relating to the purchase;
analyzing the first image using a machine learning (ML) model configured for image recognition, wherein the ML model is a supervised ML model trained to recognize items for purchase in captured images using a plurality of training data, and in response determining a first product code for the first item, comprising:
identifying the first product code as a primary product code from among a plurality of product codes for the first item;
identifying a second item relating to the first item, wherein the second item is associated with a second product code that differs from the first product code and is visually similar to the first item such that the ML model is not configured to distinguish between the first item and the second item in an image depicting one of the first item or the second item, and determining the second product code for the second item; and
transmitting the first product code and the second product code to the POS system, wherein the POS system is configured to present the first item and the second item as options for purchase using a user interface.

17. The system of claim 16, wherein identifying the first product code as the primary product code from among a plurality of product codes for the first item comprises selecting the primary product code based on at least one of: (i) determining that the primary product code comprises associated description or image data, (2) determining that the primary product code is enrolled in a retailer system, or (3) determining a numeric value relating to the primary product code.

18. The system of claim 16, wherein the first item comprises a produce item and the second item comprises an organic version of the produce item.

19. The system of claim 18, wherein the determining the second product code for the second item relating to the first item comprises searching for one or more product codes relating to the first product code.

20. The system of claim 19, wherein searching for one or more product codes relating to the first product code comprises searching for one or more product codes comprising the first product code with an added prefix value.

21. The method of claim 1, wherein identifying the first product code as a primary product code from among a plurality of product codes for the first item further comprises:
upon determining that no existing item mapping has enrolled for the first item, generating an item mapping that groups the plurality of product codes for the first item based on image, description, and a SKU code;
identifying the first product code as the primary code for the item mapping;
subsequently to determining the second product code for the second item, linking the second product code to the first product code.
